(19) United States
(12) Patent Application Publication
(10) Pub. No.: US 2011/0168491 A1
(43) Pub. Date: Jul. 14, 2011

(54) Tailgate ladder for motor vehicles

(76) Inventor: Garlin Cheatham, JR., Hartselle, AL (US)

(21) Appl. No.: 12/657,134

(22) Filed: Jan. 14, 2010

(51) Int. Cl. B60R 3/02; E06C 5/02; E06C 7/18

(52) U.S. Cl. 182/106; 280/166

(57) ABSTRACT

An access apparatus for tailgated vehicles is provide having a slideable bar located within the top platform with rotatable ladder attached to the slide bar. A safety grab bar is provide with a spring loaded locking bar. The entire apparatus is removable by simply removing the four (4) mechanical fasteners and one (1) mounting knob.

### BRIEF DESCRIPTION OF THE DRAWINGS

The present invention is described with reference to the accompanying drawings. In the drawings, like reference numbers indicated identical or functionally similar elements. Additionally, the leftmost digit (s) of a reference number indicates the drawing in which reference numbers appears.

FIG. 1 is a perspective view of a tailgate access apparatus.

FIG. 2 is an elevation of the tailgate access apparatus of FIG. 1.

FIG. 3 is a side view of the tailgate access apparatus installed on a motor vehicle.

FIG. 4 is a plan view of the tailgate access apparatus installed inside a vehicle with tail gate closed.

### DETAILED DESCRIPTION OF THE DRAWINGS

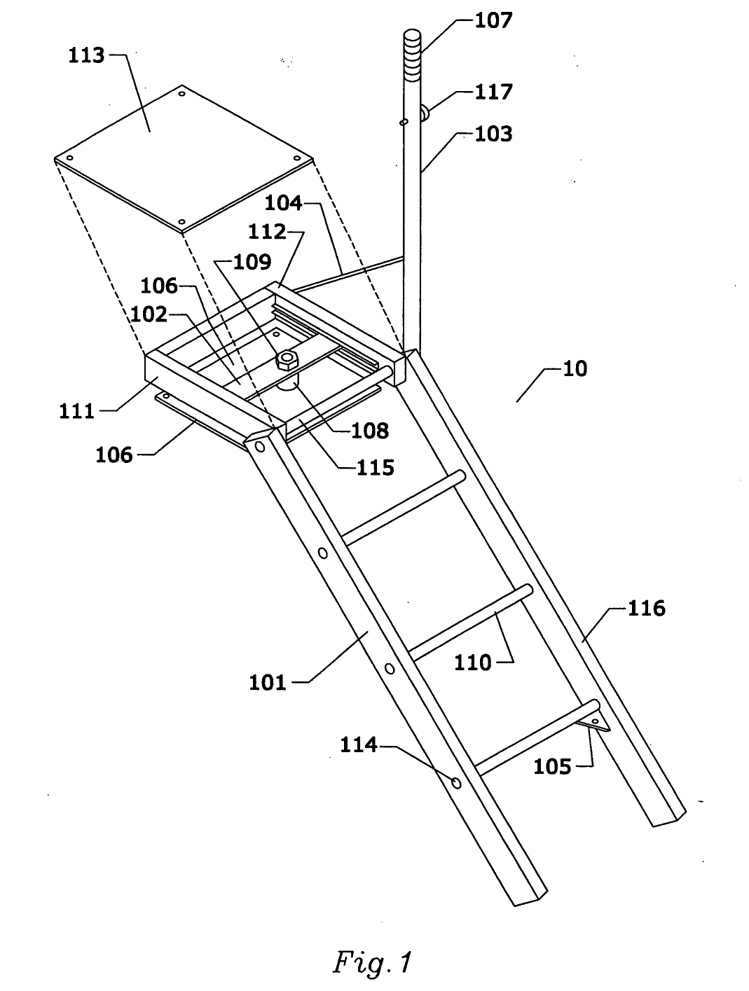

The various embodiments of the present invention and their advantages are best understood by referring to FIGS. 1 through 4 of the drawings. The elements of the drawings are not necessarily to scale, emphasis instead being placed upon clearly illustrating the principles of the invention. Throughout the drawings like numbers are used for like and corresponding parts of the various drawings.

The drawings represent and illustrate examples of the embodiment of the invention, and not a limitation thereof. It will be apparent to those skilled in the art that various modifications and variations can be made in the present invention without departing from the scope and spirit of the invention as described therein. For instance, features illustrated or described as part of one embodiment can be included in another embodiment to yield a still further embodiment. Moreover, variation in selection of materials and/or chrematistics may be practiced to satisfy particular desired user criterion. Thus, it is intended the present invention covers such modification as come with the scope of the features and their equivalents.

Furthermore, reference in the specifications to “an embodiment”, “one embodiment”, “various embodiment”, or any variant thereof means that a particular embodiment is included in a least one embodiment of the present invention. Thus the Appearance of the phrases “in one embodiment,” “in another embodiment” or variations thereof invarious places throughout the specification are not necessarily all referring to the respective embodiment.

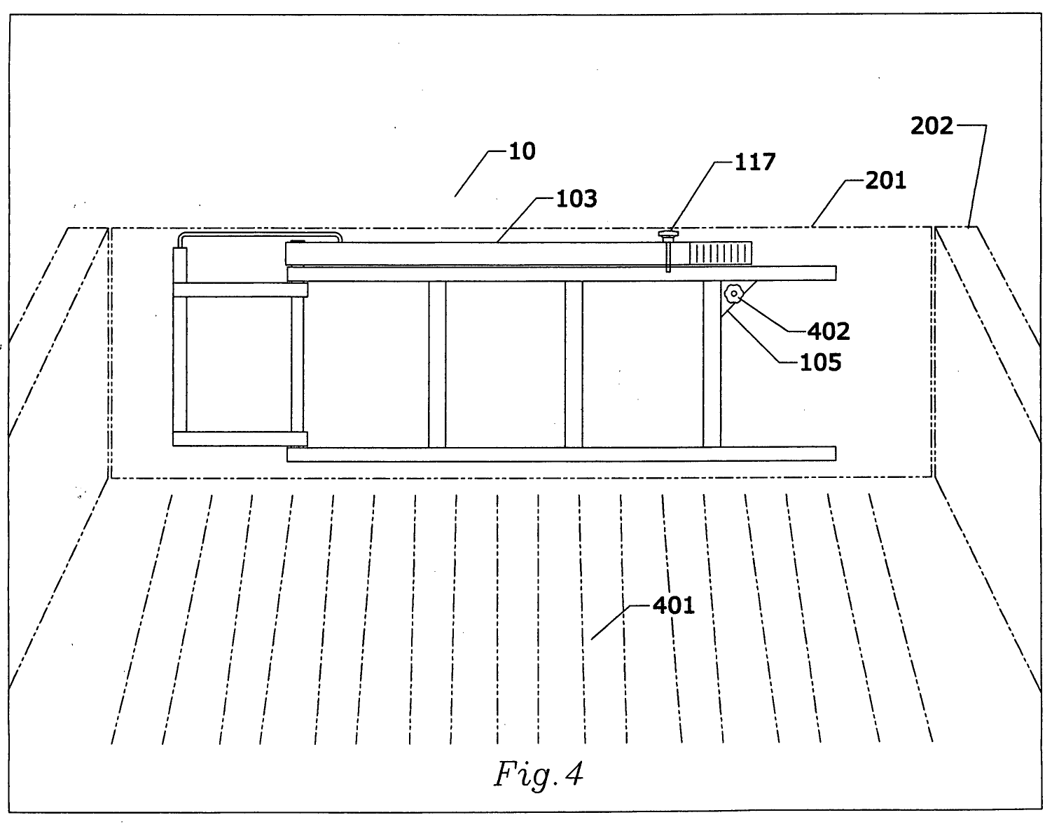

Shown in FIG. 1, an embodiment of the exemplary tailgate apparatus 10 includes a slideable bar 102 mounting in channels 111,112 on either end. Ladder rail 101,116 are rotatingly mounted to top bar 115 which is mounted to channels 111,112 and further rotatingly mounted to hand support 103. In this exemplary embodiment hand support 103 is capped by grip 107 and supported by rod 104 which is spring retractably loaded and rotatingly mounted to mounting channel 112. A bottom plate 106 is revoltingly mounted to slideable bar 102 by locking swivel bolt 109 thru spacing cylinder 108. Ladder rungs 110 are mounted to ladder rail 101,116 and capped with end caps 114. Top plate 113 is mechanically connected to mounting channels 111,112. Clip 105 is mounted to side rail 116 for mechanical mounting to tailgate 201. Spring loaded knob 117 is strategically located for locking to ladder rail 116 as shown in FIG. 4.

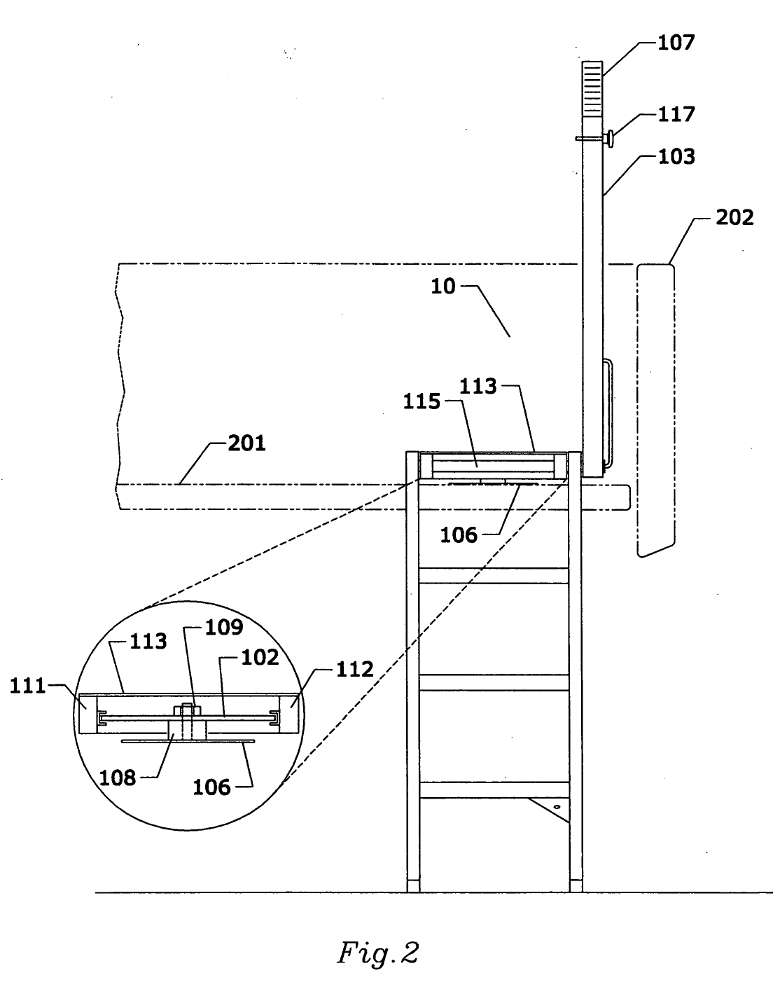

With reference to FIG. 2, plate 106 is mounted to tailgate 201 of truck bed 2 02. As shown in greater detail in the magnified view slideable bar 102 is covered by top plate 113. Bottom plate 106 being mechanically connected to tailgate 201 and revoltingly connected to bar 102 via locking bolt 109 thru spacing cylinder 108 and into holding side channels 111,112 thus allowing slideable bar 102 to move horizontally while rod 115 being rotatingly connected to slide channels 111,112 allowing vertical movement. The entire embodiment of the exemplary tailgate apparatus can be moved vertically and horizontally with referenced to the tailgate 201.

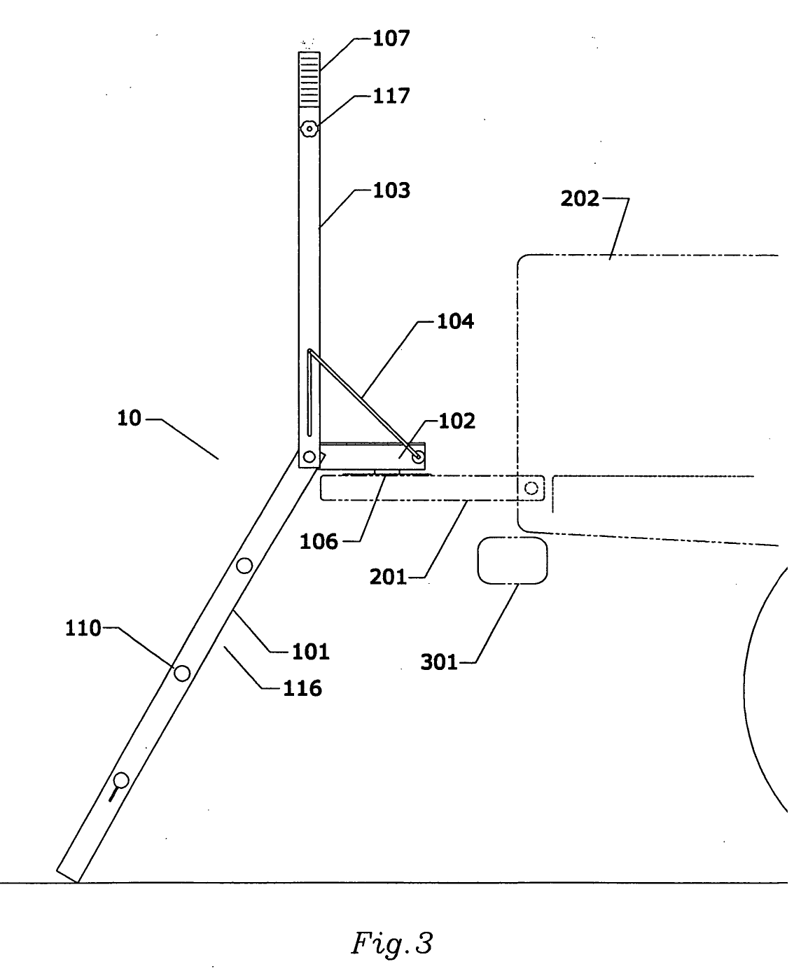

FIG. 3 illustrates the apparatus 10 installed on a truck tailgate 201. A truck typically includes a bed 202 with tailgate 201 covering bumper 301 when in the open position. The tailgate ladder apparatus is installed on the top inside of tailgate 201 by fasteners inserted into the metal surface (not shown) of the tailgate 201. The truck tailgate apparatus 10 is installed so that when slidebar 102 (not shown) is in the outward position and support handle 103 locked vertically by means of rod 104 and side support 101 and 116 rotated downward the truck bed 202 can be easily entered and exited via ladder rungs 110 and use of hand support bar 103 capped with grip 107.

FIG. 4 illustrates the apparatus 10 installed on a truck tailgate 201 in the closed inside position. The apparatus is held in position by locking knob 402 mechanically fastened to tailgate 201 thru clip 105. Spring loaded knob 117 holds hand support 103 in a locked position. Thus truck interior bed 401 remains clear of obstructions.

Operation of the tailgate apparatus will now be described. To enter the bed of the vehicle, the tailgate should be opened and lowered to its lowest (90 degree) point. Spring loaded rod 104 is pulled outward thus unlocking rod 104 from hand support rod 103. Spring loaded knob 117 is pull outward thus unlocking hand support rod 103. Hand support rod 103 is raised upward to the 90 degree position and spring loaded support rod 104 raised and inserted into hand support rod 103. Knob 402 is mechanically removed from the tailgate and apparatus 10 rotated 90 degree while pulling outward thus sliding the entire apparatus (via slideable bar 102) outward and lowering the ladder apparatus (side rails 101,116 with connecting rungs 110) to the ground by virtue of rotatingly connected rod 115. The operator can now safety enter the truck bed by virtue of the ladder, (101 and 116 with connecting rungs 110), while holding to hand support bar 103 with hand grip 107.

It will be appreciated that the tailgate apparatus disclosed herein is useful to anyone wishing to enter or exit a truck bed. Accordingly side support 101, 116 with connecting rungs 110 can be of varying lengths with consideration of truck width.

The above described tailgate apparatus has many advantages over any know to exist. The present invention is easily installed by one person, operated by one person, easily stored, requires no modification to the vehicle and protrudes less than 3″ into the truck bed allowing full use of said truck bed.

As described above and shown in the associated drawings the present invention comprises a tailgate entry apparatus for virtually any truck tailgate vehicle. While tailgate particular embodiments of the invention have been described, it will be understood, however, that the invention is not limited thereto, since modifications made by those skilled in the art particularly in light of the aforegoing teachings. It is therefore, contemplated by the following claims to cover any such modification that incorporates those features or improvements that embody the spirit and scope of the present invention.

1. An access apparatus for vehicle having a tailgated bed.
a. A rotatable ladder apparatus secured to the tailgate with mechanical fasteners.
b. A removable mechanical fastening knob located near the bottom of the ladder apparatus for securing the rotatable ladder to the tailgate.
c. A slideable bar located within the secured top platform of the ladder apparatus.
d. A vertically rotatable ladder mounted to the slide plate.
e. A rotatable safety handle mounted to slide plate.
f. A spring retractable locking bar mounted to the platform;
g. An access ladder that extends generally downward from the tailgate to the ground with a safety handle extending generally vertical.

2. The access ladder apparatus of claim 2, when mounted to a vehicle tailgate takes less than 3″ of bed space thus allowing full use of vehicle bed.

3. The access ladder apparatus of claim 3, is rotatable and slideable to insure safe and easy assertion and dissention from truck bed.

4. The access ladder apparatus of claim 4, extends generally downward at any angle.

5. The access ladder apparatus of claim 5, has a generally vertical grab handle to assure balance during assention and dissention.

6. The access ladder apparatus of claim 1, is completely removable by removing the provided mechanical fasteners.

7. The access ladder of claim 1, is one (1) unit mountable by four (4) mechanical fasteners and one (1) mounting knob.
